(19) United States
(12) Patent Application Publication
(10) Pub. No.: US 2008/0260465 A1
(43) Pub. Date: Oct. 23, 2008

(54) FILER FOR THE PURIFICATION OF CONTAMINATED WATER

(76) Inventor: John Hurst, Encinitas, CA (US)

Correspondence Address: LAW OFFICE OF DONALD L. WENSKAY, 16909 VIA DE SANTA FE, 200, P.O. BOX 7206, RANCHO SANTA FE, CA, 92057, US

(21) Appl. No.: 12/052,716

(22) Filed: Mar. 20, 2008

Related U.S. Application Data
(63) Continuation-in-part of application No. 11/343,150, filed on Jan. 30, 2006.
Application No. 11/343,150 is a continuation-in-part of application No. 10/980,941, filed on Nov. 3, 2004, now Pat. No. 7,208,082.

(51) Int. Cl. B01D 27/00; E02B 7/00

(52) U.S. Cl. 405/87; 210/505; 210/800

(57) ABSTRACT

In one embodiment of the invention, a filter assembly for filtering a fluid flowing from a first container into a second container comprises a filter panel disposed in a partition between the first and second containers. The filter panel may include a bristle filter and a frame that holds the bristle filter, and the bristle filter may include a plurality of bristles attached at their proximate ends in an adjacent configuration along the length of a base. The filter panel may be disposed such that the upper ends of the bristles are above a top surface of the fluid in the first container and the lower ends of the bristles are below the top surface of the fluid in the first container.

### REFERENCE TO RELATED APPLICATIONS

This application is a continuation-in-part of U.S. patent application Ser. No. 11/343,150, which is a continuation-part of U.S. patent application Ser. No. 10/980,941, filed Nov. 3, 2004 entitled Drainage Water Filter for Erosion Control, which is incorporated by reference herein in its entirety. This application is also related to U.S. patent application Ser. No. 11/591,921, which is incorporated by reference herein in its entirety.

### BACKGROUND OF THE INVENTION

1. Field of the Invention

This invention relates to apparatus and methods for the clarification of wastewater and, more particularly, to apparatus and method of clarifying water in a collecting pond.

2. Description of Related Art

Much importance has recently been placed on the reduction of effluent levels of contaminants in wastewater due to environmental considerations. For instance, the high demand on water resources and landfills resulting from increased industrialization and population growth are problems facing the global community. With the environmental regulations becoming increasingly more stringent, there is a growing need for more efficient and cost effective methods for abatement. For practical, economic and environmental reasons, water must be separated from contaminants and re-used or discharged into the environment.

Contaminants in wastewater often cause the water to appear turbid or colored. These contaminants include suspended and colloidal materials and soluble substances. Because the density of many of these particles is only slightly greater than water, particles can be removed by sedimentation. The clarified water then can be either discharged or reused and the sediment can be collected, dewatered and recycled or disposed of as a solid material. However, industrial wastewater generally contains contaminants such as suspended solids, dissolved organic matters, and heavy metals at levels considered hazardous to the environment and which could pose a risk to public health. Such contaminants must be removed or their levels reduced to legally acceptable levels prior to discharging the water to the environment.

One example of industrial wastewater is water used in cement production. Cement mixers at processing plants and cement trucks are frequently cleaned out with water to prevent hardening of the remnant concreter therein. The resulting cement slurry may then be placed in a settling tank or holding pits where aggregate from the waste concreter may be reclaimed. The water separated from the cement slurry will then need to be further clarified before it can be disposed of or reused.

One way to separate water from such cement slurry is to place the slurry into a series of pits where the cement solids may be settled out. Successive pits may be separated by weirs so that clarified water at the top of the surface may pass from one pit to the next, where additional settling occurs. The pits are effective in settling out the aggregate from the water so that the aggregate can be reused. However, at the end of the process, the water may still not be purified enough for disposal or reuse. One reason for this is that the cement slurry contains substances that float in the water. These floating contaminants easily pass over the weir from pit to pit until they reach the final pit.

One way to address this problem is to install a metal blocking plate partially over the weir intake opening such that the bottom of the plate is submerged some distance below the waterline. As a result, only water below the level of the submerged blocking plate surface will pass through the weir. For example, the blocking plate may be several inches below the water surface. Unfortunately, this kind of blocking plate is only partially effective in preventing floating contaminants from passing through the weir. One problem is that when the pit is filling, floating contaminants at the surface can pass under the blocking plate before the level of the water rises above the bottom the blocking plate. Another problem is that some contaminants, while generally near the surface, may also be partially submerged and thereby pass under the blocking plate.

Besides the above example, there are numerous other examples of industrial, mining and municipal water treatment processes where ponds or pits are used to settle out heavier particles from the water. In many of these processes, it can be difficult to remove lighter and floating contaminants in the water for the reasons discussed above.

From the foregoing it can be seen that a need exists for improved apparatus and methods for removing contaminants from a wastewater stream. There is also a need for improved apparatus and methods for clarifying water in settling pits or ponds and particularly for methods for removing floating contaminants in settling pits.

### SUMMARY OF THE INVENTION

To overcome the limitations in the prior art briefly described above, the present invention provides an apparatus and method of purifying contaminated water in settling ponds.

In one embodiment of the invention, a filter assembly for filtering a fluid flowing from a first container into a second container comprises: a filter panel disposed in a partition between the first and second containers; the filter panel including a bristle filter and a frame that holds the bristle filter, the bristle filter including a plurality of bristles attached at their proximate ends in an adjacent configuration along the length of a base; the filter panel disposed such that the upper ends of the bristles are above a top surface of the fluid in the first container and the lower ends of the bristles are below the top surface of the fluid in the first container.

In another embodiment of the invention, a system for filtering liquid comprises: first and second pits each containing a liquid; a wall separating the pits; a weir disposed at the top edge of the wall such that fluid flowing from the first pit to the second pit passes through the weir; and a filter panel disposed in the weir, the filter panel including a bristle filter and a frame that holds the bristle filter, the bristle filter including a plurality of bristles attached at their proximate ends.

In a further embodiment of the invention, a method of filtering sediment-laden liquid and removing deposited sediment from the liquid comprises: situating a filter panel in a first operational position proximate the top edge of a partition between first and second liquid containers, the filter panel comprising a bristle filter and a frame that holds the bristle filter, the bristle filter including a plurality of bristles attached at their proximate ends in an adjacent configuration along the length of a base; and allowing the liquid to flow through the filter panel, from the first container to the second container, thereby filtering substances near the top of the surface of the fluid in the first container.

Various advantages and features of novelty, which characterize the present invention, are pointed out with particularity in the claims annexed hereto and form a part hereof. However, for a better understanding of the invention and its advantages, reference should be made to the accompanying descriptive matter together with the corresponding drawings which form a further part hereof, in which there is described and illustrated specific examples in accordance with the present invention.

### BRIEF DESCRIPTION OF THE DRAWINGS

For a more complete understanding of this invention, reference is now made to the following detailed description of the embodiments as illustrated in the accompanying drawing, wherein:

FIG. 1 is a perspective view of a rotatable filter assembly including a panel filter and pivotable mounts on each end that allow rotation between a downward (operational) position and an upward (cleaning) position;

FIG. 2 is an exploded, perspective view of the filter panel including the bristle filter;

FIG. 3 is a perspective view of a curbside storm drain and a rotatable filter assembly, illustrating one of the ways in which the assembly can be attached to the storm drain;

FIG. 4 is a perspective view of a curbside storm drain and the filter assembly positioned on the storm drain, illustrating a downward position in solid lines and an upwardly rotated position in dashed lines;

FIG. 5A is a cross-sectional view of a bristle filter panel in flowing drainage water, illustrating sediment (and/or other debris and contaminants) collecting in front of the panel;

FIG. 5B is a cross-sectional view of the filter assembly as in FIG. 5A, illustrating flowing drainage water at a later point in time after which a significant amount of sediment (and/or other debris and contaminants) has built up in front of the bristle filter panel;

FIG. 5C is a cross-sectional view of the filter assembly as in FIG. 5B, after the water has stopped flowing, illustrating the panel rotated upward;

FIG. 5D is a cross-sectional view of the filter assembly as in FIG. 5C, after the sediment (and/or other debris and contaminants) has been removed (such as by street sweeping), illustrating the panel rotated back into position in front of the storm drain;

FIG. 6 is a flowchart of operations illustrating the sequence of positioning the filter and then cleaning after sediment has built up, with reference figures listed in the box as appropriate;

FIG. 7 is a perspective view of a stand-alone (washout) storm drain and plurality of filter assemblies positioned in a frame surrounding the storm drain;

FIG. 8 is perspective view of a prior art in-ground concrete system having a series of four pits;

FIG. 9 is a perspective view of a prior art weir used in the pits shown in FIG. 8;

FIG. 10 is a perspective view of a weir having a filtering system in accordance with an embodiment of the invention;

FIG. 11 is a cut-away view of a weir having a filtering system showing flow direction and bristle orientation in accordance with an embodiment of the invention;

FIG. 12 is a perspective view of a mounting bracket for a weir filtering system in accordance with an embodiment of the invention;

FIG. 13 is a perspective view of a mounting bracket for the weir filtering system in accordance with another embodiment of the invention; and

FIG. 14 is a perspective view of an alternative mounting bracket assembly for the weir filtering system in accordance with another embodiment of the invention.

### DETAILED DESCRIPTION

This invention is described herein with reference to the figures, in which like numbers represent the same or similar elements.

### Overview

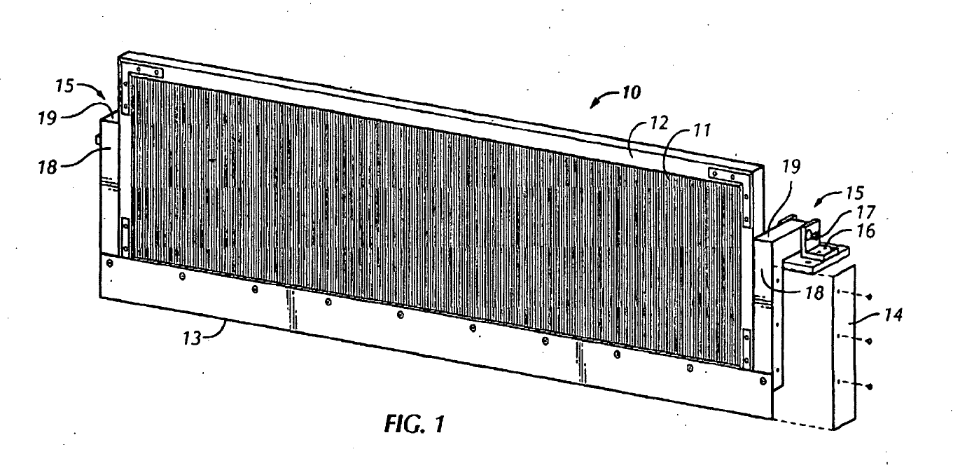

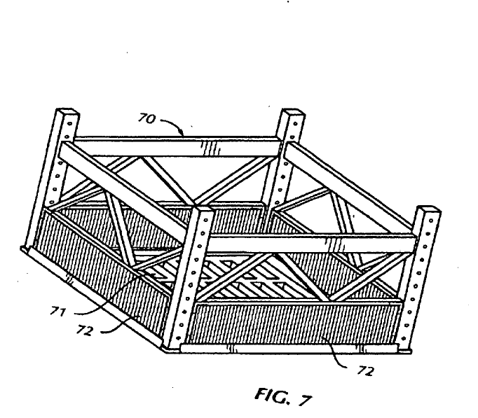

A filtering system is disclosed herein that utilizes a filter assembly that includes a bristle filter for filtering out contaminants flowing across a weir in a settling pit. The filtering system is adapted from a storm water filer system described in U.S. patent application Ser. No. 11/343,150, which was previously incorporated by reference. FIGS. 1-7 show details of the storm water filter system in this incorporated-by reference patent application. FIGS. 9-14 show various embodiments in which the filter system shown in FIGS. 1-7 may be adapted to a weir filter system used in a settling pit.

As shown in FIGS. 1-7, a filtering system is disclosed herein that utilizes a filter assembly that includes a bristle filter for filtering out dirt, sand, rock, debris, and possibly other contaminants (such as oil) in drainage water run-off, and preventing it from entering into a water drainage system.

The filtering system is described herein in the context of construction sites that have a large amount of broken ground and a correspondingly large amount of dirt- and rock-laden run-off; however, it could also be used in other locations, for other drainage systems, and in a variety of implementations such as municipalities or other governing bodies that may be required to filter drainage water. In one implementation described herein, a bristle filter is affixed to a frame that is designed to pivotally hold the filter assembly against a curbside storm drain. The frame has a configuration to surround the storm drain and situate the bristle filter in a position to filter drainage water and protect the storm drain against contamination. In one embodiment, the bristle filter panel is rotatable, which advantageously allows it to easily conform its shape to different road surface elevations and irregularities.

### Storm Drain Background Information

A storm drain includes an inlet positioned to receive drainage water, which is then directed using a drainage system that typically includes a network of pipes and conduits to a disposal area. Via this drainage system, typically the run-off water eventually flows into another body of water, such as a river, lake, or ocean. In land-locked locations, the run-off water may be directed to a low-lying area from which it can drain into the ground water, or evaporate.

Storm drains may have a number of forms, such as a curbside storm drain that has an inlet positioned to receive water as it flows along a curb, or a “stand-alone” storm drain (wash-out) that has an inlet anywhere on a surface where water would normally collect, such as a low point in a road or intersection. Usually, storm drains are discussed in the context of a paved surface; however, storm drains may also be implemented on non-paved surfaces, such as rock, gravel, or dirt.

### Description of Filter Assembly and Pivotable Mount

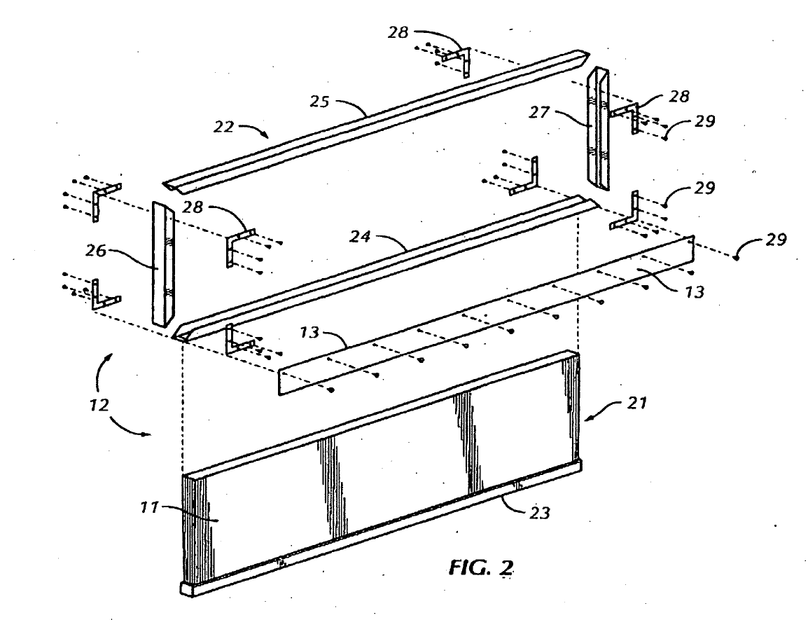

Reference is made to FIGS. 1 and 2 to disclose one embodiment of a filter panel and a pivotable mount. It should be apparent that other embodiments with different constructions can provide a suitable filter panel and a pivotable mount.

Any suitable structural components may be utilized to implement the panel and the pivotable mount. For example, the panel may be constructed of readily available metal struts and connectors to fit the size requirements of the storm drain, and/or it may be constructed of non-metallic struts and connectors such as those manufactured by Seasafe, Inc. of Lafayette, La. (www.seasafe.com).

FIG. 1 is a perspective view of one filter assembly 10 that includes a bristle filter panel 12 and a pivotable mount 15. FIG. 2 is an exploded view of one embodiment of a filter panel 12. Generally, the filter panel has a construction including a bristle filter that has a plurality of bristles 11 arranged vertically against the flow of drainage water.

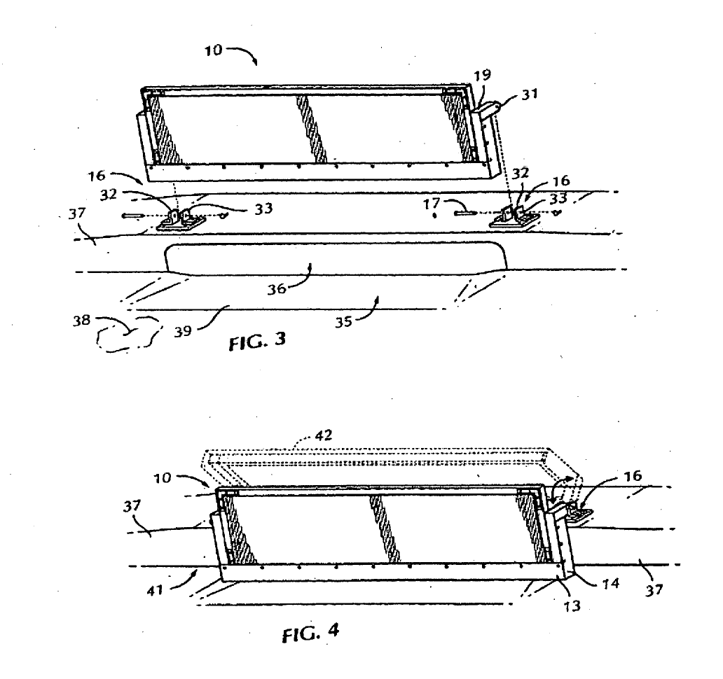

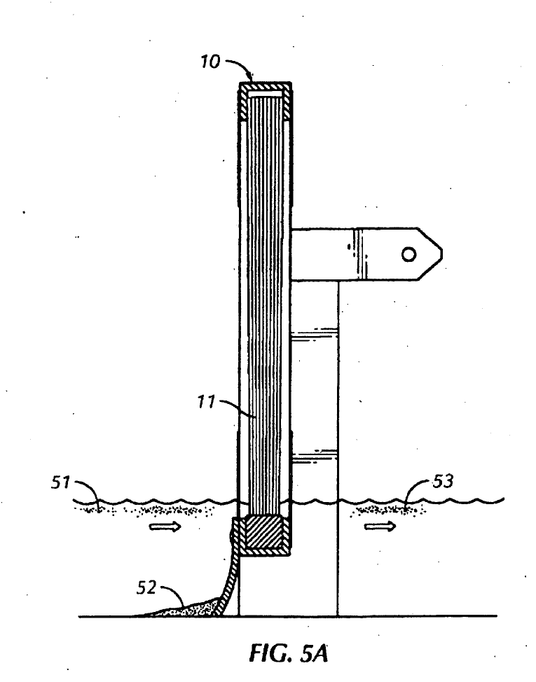

In addition to the filter panel and the pivotable mount, the filter assembly 10 includes a lower seal 13 affixed to the lower end of the filter panel, and a pair of side seals 14 affixed to the mount. In FIG. 1, for illustration purposes, one of the side seals 14 is shown exploded from the leg 18 to which it is attached; it should be clear that the side seals are affixed in the front by a group of fasteners, in a configuration that allows the back (the part facing the curb) to extend beyond the beam in a backward direction to engage with the curb. The seal comprises a flexible material such as thick rubber having a configuration to cover the gap between the adjacent surfaces, such as the road or curb surface (as discussed with reference to FIGS. 3 and 4). Particularly, the lower flexible seal 13 is affixed to the filter panel, and is arranged to cover the gap between the filter panel and the surface, thereby directing water to the plurality of bristles. The side seals 14 are connected respectively to each of the L-shaped beams, and the seals are arranged to cover the gap between the filter panel and the curb. The flexibility of the lower seal and the side seals allows it to conform (i.e., bend) to variations in the road, while still maintaining a substantially watertight seal.

As shown in FIG. 1, the pivotable mount includes a mounting bracket 16 and an L-shaped beam that has a first leg 18 and a second leg 19. The L-shaped beam has its first leg 18 connected to the side of the filter panel 12. The second leg 19 extends backwards to pivotally connect with the bracket 16. Referring briefly to FIG. 3, in this embodiment, the second leg 19 includes a hole 31 formed proximate to the mounting bracket 16. The mounting bracket 16 includes a corresponding receiving section that has two extended flanges 32, and the second leg 19 fits between the two flanges. A locking pin 17 is used to pivotably secure the second pin between the two flanges: particularly the locking pin 17 extends through holes 33 in each of the flanges, and the hole 31 in the second leg, in order to allow pivotal motion about the locking pin 17.

FIG. 2 is an exploded view of one filter assembly 29 that comprises filter components including a bristle filter panel 12. The filter panel includes a bristle filter and a plurality of structural components interconnected by suitable connectors. Advantageously, the rail and the bristle can be designed and implemented to save cost, and even to use off-the-shelf components.

The bristle filter panel 12 includes bristle filter 21 and structural panel components shown generally at 22. Generally, the bristle filter 21 includes the plurality of bristles 11 and a beam 23 to which the bristles are affixed at their lower ends in this embodiment. Specifically, the bristle filter panel includes a plurality of stiff but flexible bristles 11 bundled together at their lower ends, and held by the beam 23. The lower beam 23 holds the upper ends of the bristles together, and it may be rigid, or it may have some flexibility as appropriate for the desired use.

The bristles 11, held in place at their ends by the beam 23, are arranged in a configuration as appropriate for the intended use; typically, the ends of the bristles are affixed closely adjacent to each other. The affixed ends of the bristles are connected to the beam by any suitable means, such as glue and/or pressure provided by the beam (e.g., crimping by the beam), or molding. If the affixed ends of the bristles are positioned adjacent to each other, then the bristle density is determined by how closely the bristles can be practically positioned together. The bristles are oriented approximately perpendicular to the beam; however, in alternative embodiments, the bristles may have a non-perpendicular orientation in any direction. The bristles 11 have a length, diameter, stiffness, and material chosen to provide the desired filtering action and a sufficient structural strength to withstand the force of flowing drainage water. For example, in one embodiment the bristles have a length of about 12.0 inches, a diameter of about 0.1 inch, and are comprised of polypropylene.

Generally, the bristles have a particular length, diameter, and arrangement as determined by the particular design and intended application. For example, the bristle's length and diameter are determined by design considerations such as the flexibility and strength of the bristles, and the particular material used. The arrangement of the bristles (e.g., the density and number of bristles) presented to the flowing water is also determined by design considerations; particularly, the bristles are arranged with an appropriate depth from the front edge sufficient to withstand the force of flowing water; for example, if the bristles are formed of a relatively stiff material (e.g., polypropylene), and have a diameter of about 0.1″, a depth of four or five bristles from the front edge to the back edge may be sufficient.

One particularly advantageous material for the bristles 11 is polypropylene, which has been observed to “collect” oils, hydrocarbons, and organic compounds from the surface of water, and to adhere to the surface of the polypropylene bristles, which is very useful. Since the bristles “collect” such compounds by adherence, and the filter can be removed and cleaned to remove the collected compounds that adhere to the bristles, such a function can be particularly useful to reduce the amount of hydrocarbons and other organic compounds in drainage water run-off, as will be described in more detail.

The panel components shown generally at 22 include a plurality of rails 24, 25, 26, and 27, a plurality of L-brackets 28 that connect the rails at the corners, and a plurality of connectors 29, such as screws or rivets that connect the L-brackets to the rails. The rails have a configuration to accept and receive the bristle filter 21; particularly a lower rail 24 has an interior section to engage the connecting beam 23, an upper rail 25 has an interior section to engage the loose ends of the bristles 11, and two side rails 26 and 27 have interior sections to engage the side bristles of the bristle filter 21.

### Description of Curbside Storm Drain Filter Assembly

Reference is now made to FIGS. 3 and 4. FIG. 3 shows a curbside storm drain 35 that includes an inlet 36, formed as an opening in a curb 37, and a road 38 that has a downward sloping section 39 that leads water to the inlet 36. The inlet 36 then directs drainage water, via a system of pipes and conduits (not shown), to a drainage water disposal area.

FIGS. 1 and 2 (discussed above) show views of a curbside filter assembly 10. In FIG. 3, the filter assembly 10 is illustrated in perspective view, “floating” above the storm drain 35. Dashed lines drawn from the filter assembly show how the pair of second arms 19 is positioned respectively within the pair of mounting brackets 16.

Each mounting bracket 16 is affixed to the sidewalk proximate to the storm drain by any suitable attachment system, such as by screws in concrete, or by an adhesive. In this embodiment, the two brackets 16 are positioned proximate to the opposite ends of the inlet, with a separation that matches the distance between the pair of second arms.

The filter assembly 10 has a length sufficient to cover the inlet opening in the storm drain. Because the length of the inlet opening varies from storm drain to storm drain (generally determined by engineers to meet water flow requirements), the filter assembly 10 cannot have a single standard size, but instead may be provided in a variety of lengths in order to accommodate the various storm drains. In other words, since storm drain inlets have varying lengths, the filter panels may be provided in a number of different lengths, and during installation, the appropriate length of the filter panel can be selected to accommodate the length of the particular inlets. Thus, the filter assembly can be assembled easily, transported efficiently, and stored in a small area, all of which can be advantageous.

In FIG. 4, the filter assembly 10 has been affixed into the brackets 16. The filter assembly shown in solid lines is in operational position 41 on the storm drain. In this first (operational) position 41, the side seals 14 cover the gap between the L-shaped mounting bracket and the adjacent portion of the curb, and the lower seal covers the gap between the filter panel and the road.

In a second (upwardly-rotated) position, as shown in dashed lines at 42, the filter assembly 10 has been removed from the inlet of the storm drain, and rests in a position above the storm drain. In this second position, the sediment in front of the inlet can be cleaned away, and the inlet can be accessed easily. Furthermore, the filter assembly 10 can be detached from the curb (as shown in FIG. 3), and then transported to a remote location for cleaning, such as by power washing. After cleaning, it can then be re-installed.

### Method of Operation

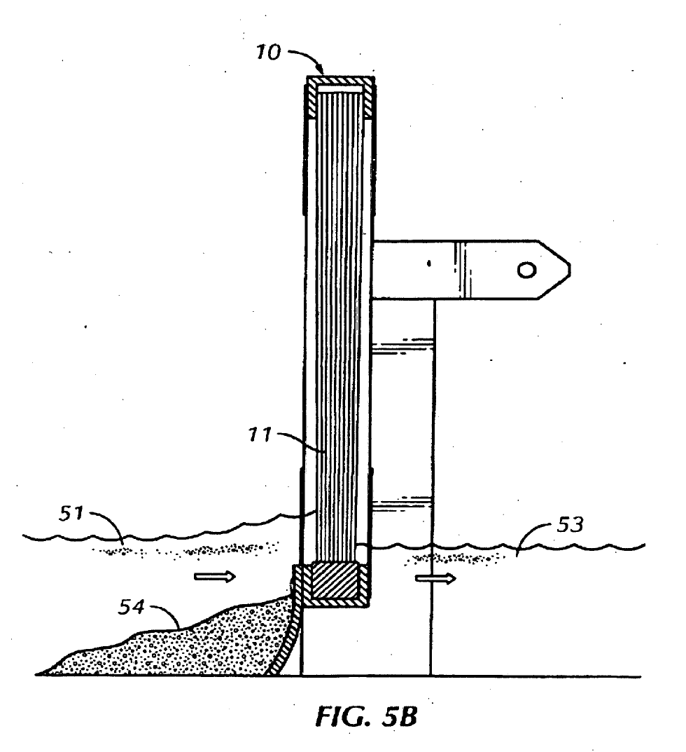

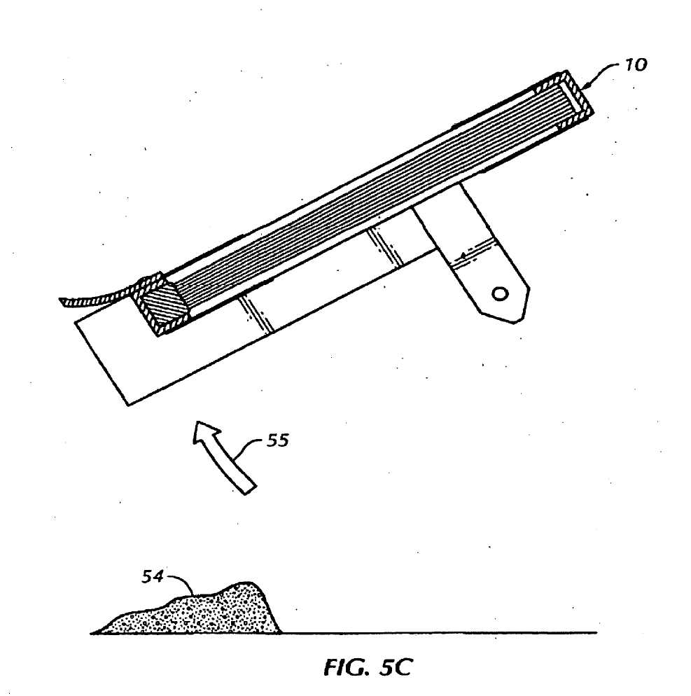

Reference is now made to FIGS. 5A, 5B, 5C, 5D, and 6 to describe a method of operation in which drainage water is filtered by a filter assembly 10, and then sediment is removed (and optionally the filter assembly itself is cleaned).

FIG. 5A is a cross-sectional view of the filter assembly with drainage water beginning to flow therethrough, and FIG. 5B is a cross-sectional view of the filter assembly with flowing drainage water, after significant sediment has built up in front of the filter panel. FIG. 5C a cross-sectional view of the filter assembly rotated upwardly and FIG. 5D is a cross-sectional view of the filter assembly returned to operational position after the sediment has been cleaned away. In the sectional views of FIGS. 5A, 5B, 5C, and 5D, the side seal is shown partially cut away to reveal the filter panel in cross-sectional view. For illustrative purposes in FIGS. 5A and 5B, the water flow is shown viewed through the side seal, as if it were transparent.

FIG. 6 is a flowchart of operations illustrating the sequence of positioning the filter and then cleaning after sediment has built up, with reference figures listed in the box as appropriate. At 61, the mounting brackets 16 are installed and the filter assembly 10 is affixed thereto, such as shown in FIG. 3.

At 62, the filter assembly is moved into operational position 41, such as shown in FIG. 4.

At 63, sediment buildup is observed from drainage water flowing therethrough, as shown in FIGS. 5A and 5B, when sediment-laden flowing drainage water 51 encounters the filter assembly 10, all the water is forced through the bristles 11, and sediment (e.g., dirt, silt, rocks, and debris) is stopped in front of the filter and the sediment is deposited in a small sediment deposit 51 at the leading edge of the filter assembly 10. (Water flows from left to right, as indicated by the arrows.) In addition, the drainage water 51 may contain other contaminants (such as oil), which may adhere to the surface of the bristles and/or build up in front of filter. Cleaned water 53 exits from the filter assembly, and flows into the storm drain inlet, for example.

It may be noted that over time, as the sediment deposit builds up, the water level through the bristle filter panel rises, and therefore the water flow would not be significantly constricted as the sediment builds up (at least until the water level reaches the top of the filter panel). FIG. 5B is a side view as in FIG. 5A, except that FIG. 5B shows a large sediment deposit 54 that is much deeper than the first sediment deposit 52 shown in FIG. 5A. Still, the water flow is substantially unconstricted as shown in FIG. 5B. Thus, the bristle filter panel advantageously allows water to flow through substantially unrestricted even if a significant amount of sediment has been deposited in front.

At 64, at some point in time, the flow of drainage water eventually stops. At this point, it may become desirable to perform street cleaning operations, as illustrated at 65.

At 65, if street cleaning is not desired yet, operation simply returns to a previous step, such as observing additional sediment buildup at 63. However, still at 65, if street cleaning is desired, the operation moves to 66.

At 66, the filter assembly is rotated to an upward position 42, such as shown in FIG. 4 in dashed lines, and by arrow 55 in FIG. 5C. In order to move the filter assembly for cleaning or for any other purpose, the filter assembly may be lifted by hand, or if it is too long or heavy to be practically operated by hand, machinery may be utilized, or a rope and pulley assembly (not shown) may be included.

At 67, the sediment deposit 54 is cleaned from the road surface, such as by conventional street sweeping.

At 68, optionally, the filter assembly itself may be cleaned, for purposes such as removing oil and other contaminants from the bristles. In this optional step, the filter assembly 10 may be removed (see FIG. 3), and transported to a remote location for cleaning, such as by power washing. Alternatively, a system may be provided for cleaning the filter assembly without removing it to a remote location.

When street cleaning is complete (and the optional step 68 completed if desired), the filter assembly is then placed back into operational position, as shown at 62, and operation repeats.

Thus, the filter assembly 10 may be moved to allow street sweeping, and when street cleaning is complete, the filter assembly can be rotated back to easily re-position the bristle filter panel in its operational position by the curb. Additionally, the filter assembly may be detached from the curb and cleaned in a remote location. The clean filter assembly can then be re-installed, or a new filter assembly can be installed in its place.

### Standalone Storm Drain

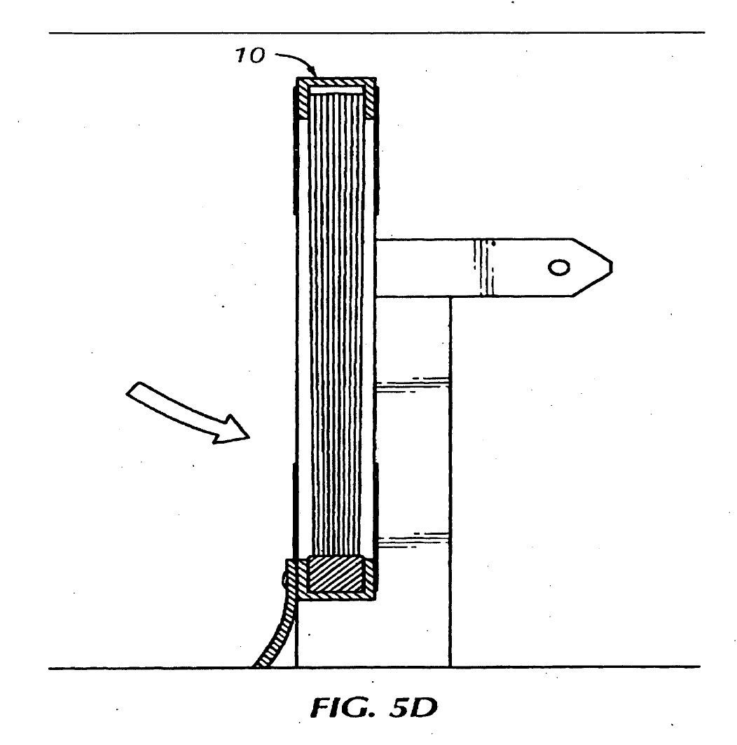

FIG. 7 is an example of an embodiment of a frame structure 70 that is designed to surround a standalone storm drain 71. Particularly, the frame structure 70 forms a closed structure that completely surrounds the sides of the standalone storm drain. At its lower end the frame structure 70 attaches to a plurality of filter panels 72, each of which includes a bristle filter panel. For example, some or all of the filter assemblies 72 may be similar or identical to the filter assembly shown in FIGS. 1 and 2.

### ALTERNATIVE EMBODIMENTS

It will be appreciated by those skilled in the art, in view of these teachings, that alternative embodiments may be implemented without deviating from the spirit or scope of the invention.

The filter assemblies may be provided in any of a number of different embodiments, some of which are discussed with reference to FIGS. 3, 4, and 7, although other embodiments are possible. Typically, the filter assembly includes at least a filter component including a bristle filter panel that has bristles positioned for filtering of large particles in water run-off, such as dirt, sand and rocks, in order to separate them from the drainage water and prevent them from flowing into the storm drain inlet.

In alternative embodiments, the filtering system may also include one or more secondary filters in addition to the primary bristle filter panel. The secondary filter can further filter the water after it passes through the bristle filter panel(s) as appropriate for a particular use. For example a screen or other filter may be situated on an additional beam within the frame to filter out smaller contaminants such as silt that goes through the primary filter(s), and/or an oil filtration bag as discussed in more detail herein, which can remove oil and/or other hydrocarbon compounds from the water as it flows by. In other words, one or more additional filters can be attached to the inside of the frame, downstream from the filter assemblies to provide further filtering. There are many types of filters available, and the frame can provide opportunities to attach these filters in a way to re-filter the water that has already been initially filtered by the primary filter.

The embodiment discussed with reference to FIGS. 3 and 4 has a configuration for holding the filter assembly including a frame designed to protect a curbside storm drain, and the embodiment discussed with reference to FIG. 7 includes a frame designed to protect a standalone storm drain; it should be apparent other suitable frame constructions and configurations may be utilized.

### Weir Filter System

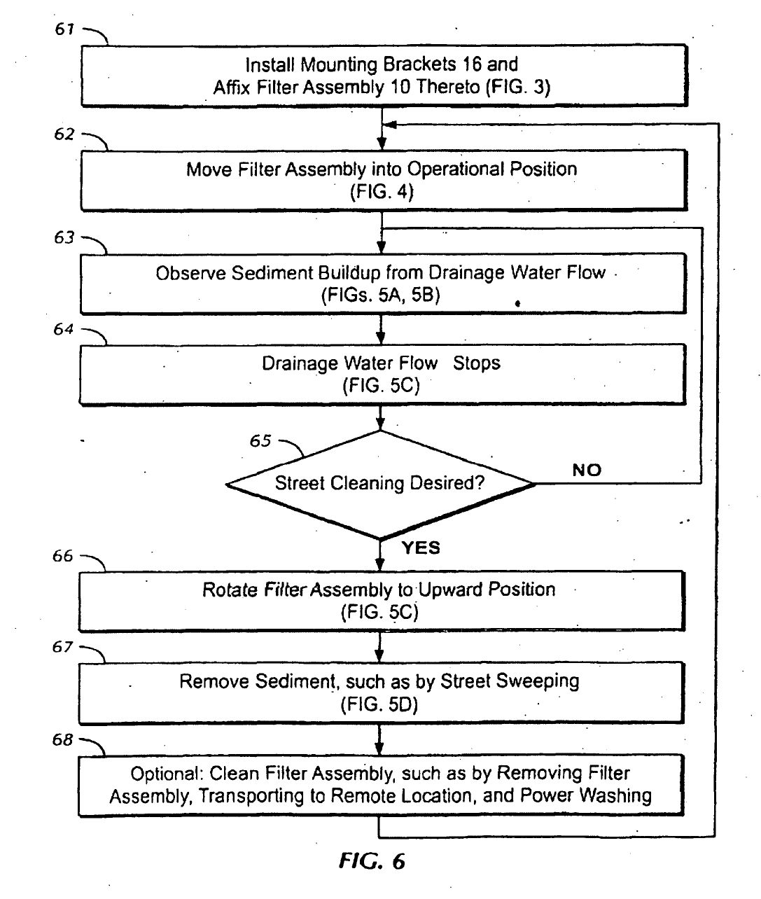

FIG. 8 shows a conventional pit system for cement slurry water clarification for concrete reclaiming apparatus. The settling pit system 10 having four pits 14, 15, 16 and 17 separated by three weirs 18. A wall 19 is shown adjacent a foundation 13. A ramp 11 is provided for truck access. In operation, after a cement truck (not shown) has delivered cement, the truck is backed up onto the ramp where the unused cement left is rinsed out the resulting mixture of cement and water, referred to as cement slurry, is unloaded in to the first pit 14. When the level of the cement slurry reaches the first weir 18, it will spill over the weir 18 into the second pit 15. Likewise when the second pit 15 fills, the cement slurry will spill over into the third pit 16 and so on until the fourth pit 17 is filled.

It will be appreciated that heavier particles in the cement slurry will settle to the bottom of each pit. Also, because the cement slurry in the succeeding pit must pass over the top of the preceding weir, fewer and fewer solid particles will reach subsequent pits. Ideally, the fourth pit 17 will contain clear water that may be less toxic and may be reused in the cement processing or otherwise disposed of. Unfortunately, some of the contaminants in the cement slurry do not sink to the bottom of the pits and pass over each weir eventually reaching the final pit 17. One such contaminant may be calcium. As a result, the water in the final pit 17 may not be suitable for reuse.

One conventional approach to address this problem is shown in FIG. 9. A weir 20 used in a settling pit is similar to weirs 18 shown in FIG. 9 except that two blocking plates 22 and 24 have been placed over each side of the weir 20. The lower edge of blocking plate 22 is located below the waterline 26 of the pit 28 on the front side of the weir 20. The waterline 26 is higher than the waterline of the pit 30 on the back side of weir 20 so that cement slurry will flow from pit 28 toward pit 30. The cement slurry will be forced to pass beneath the lower edge of blocking plate 22 before entering weir 20. As a result, contaminants floating near the surface 26 will be substantially retained by the blocking plate 22. A second blocking plate 24 may be employed at the back of the weir 20 which has an opening at its bottom to allow fluid to pass underneath while blocking substances near the surface.

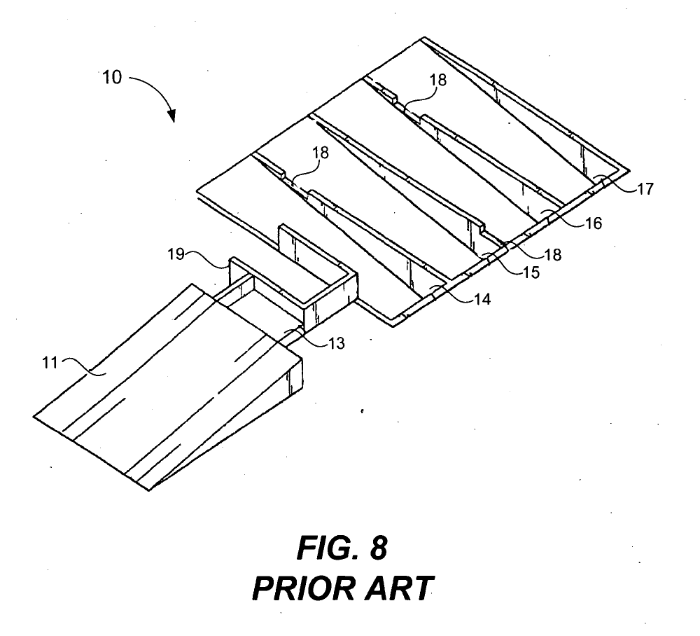

It has been found, however, that even with blocking plates 22 and 24, some contaminants near the surface 26 still pass under the blocking plates and reach the downstream pit 30 resulting in an unacceptable level of clarity and purity of the water in the final pit. To address this problem, as shown in FIG. 10, a weir filter system 32 is installed in a weir 38. This weir filter system 32 includes a pair of filter assemblies 34 and 36 located at each end of the weir 38. Filter assembly 34 is located adjacent to pit 35 and filter assembly 36 is located adjacent to pit 37. Each filter assembly 34 and 36 includes a bristle filter panel 40 including a frame 42 and a plurality of bristles 44. The details of the filter assemblies 34 and 36 may be similar to the filter assembly 12 shown in FIG. 1 and described above.

A seal 46 may be attached to the frame 42 on three sides to insure that liquid cannot pass around the sides of the filter assemblies 34 and 36. Seal 46 may be similar to flexible seal 13 shown in FIG. 1.

In operation, cement slurry passing from pit 37 into pit 35 must first pass through bristles 44 in the filter assemblies 34 and 36. Because of the particularly effective manner in which bristles 44 filter liquids, as described above, by the time cement slurry reaches the last pit, such as pit 17 in FIG. 8, it will have passed through six sets of bristles 44. As a result, a high degree of the contaminants near the surface of the cement slurry will be held back by the bristles 44 and will not reach pit 17. Thus, the water in pit 17 may in some cases be less toxic and may be suitable for reuse by cement-making processes or for disposal.

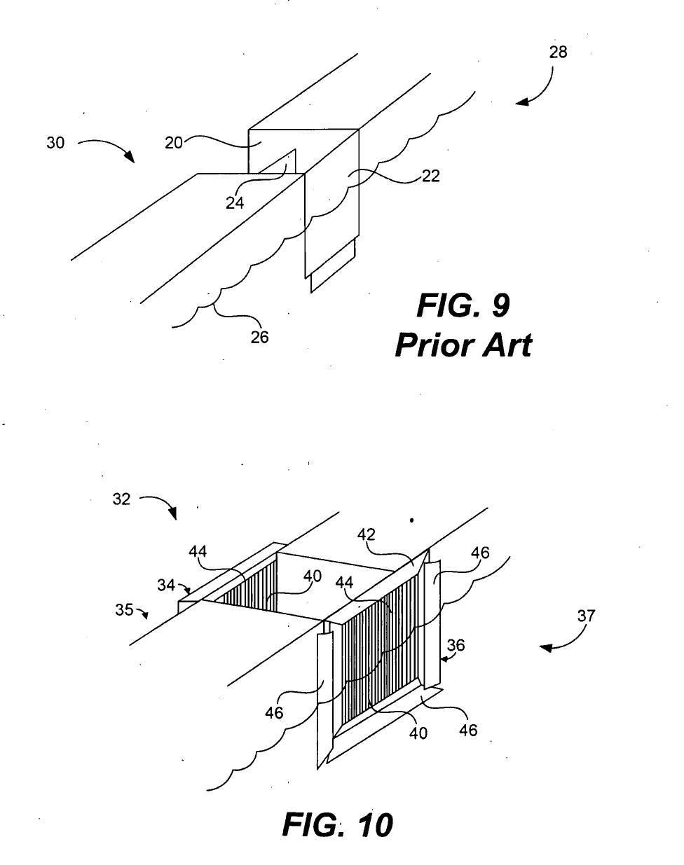

FIG. 11 shows another embodiment of a weir filter system 50 of the invention. In this embodiment, filter assemblies 52 and 54, each including bristles 56, are attached to a weir 58 located between two settling pits 60 and 62. In this case, the water level of pit 60 is higher than pit 62 so the water will flow out of pit 60 into pit 62 as indicated by an arrow. As shown in FIG. 2, bristles are bundled together at one end. Because individual bristles are held tighter together at that end, less water will flow through the bristles at that end than at the opposite end of the bristles. This difference in flow rate may be advantageously used in the present invention. For example, as shown in FIG. 11, on filter assembly 52 the bristles 56 may be orientated pointing upward as indicated by the arrow. This will cause the rate of fluid flow to be slower near the bottom of filter assembly 52 and the slower fluid flow rate will facilitate the settling of particles in suspension in the cement slurry in this region. This configuration may be desirable to facilitate the settling out of sediment near at the bottom of the filter assembly 52 so that such particles may drop to the bottom of the pit 60.

Filter assembly 54 on the other hand, has bristles orientated downward as indicated by the arrow. This may be desirable to facilitate the flow of the liquid out of the weir 58 and into pit 62. Also shown in FIG. 11 is a Velcro strip 64 attached to the filter assembly 54 for attachment to the side of the pit 62. Additional Velcro strips (not shown) may be used on the other sides of filter assembly 54 and also on filter assembly 52.

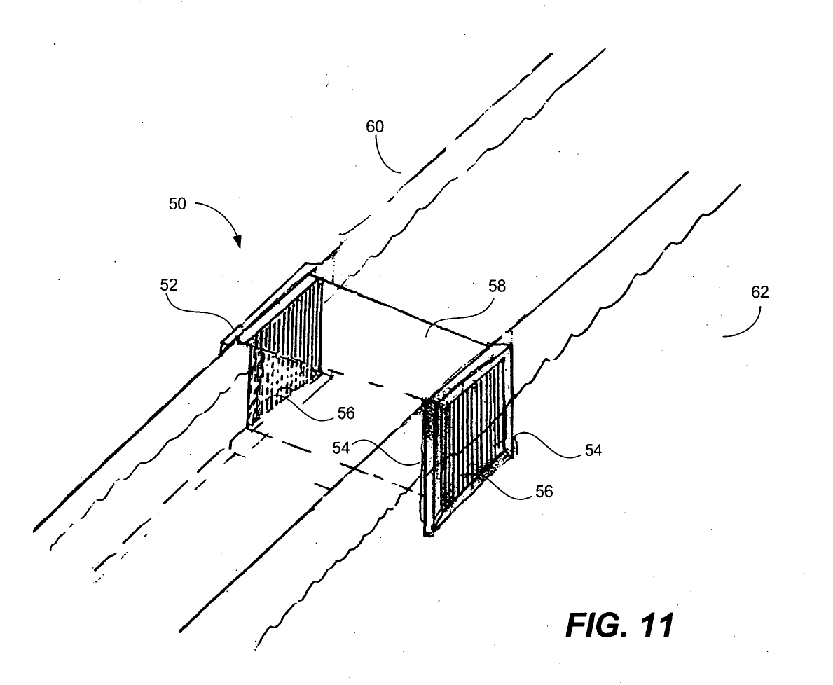

FIG. 12 shows an alternate mounting assembly 66 for attaching the filter assembly 54 to the wall of pit 62. Mounting assembly 66 includes a pair of opposing L brackets 68 and 70 attached to the weir 58 surface. This configuration creates a channel 72 into which the frame of filter assemblies 52 and 54 may slide downward into. This embodiment makes it easy to remove and reinstall filter assemblies 52 and 54, for example for cleaning.

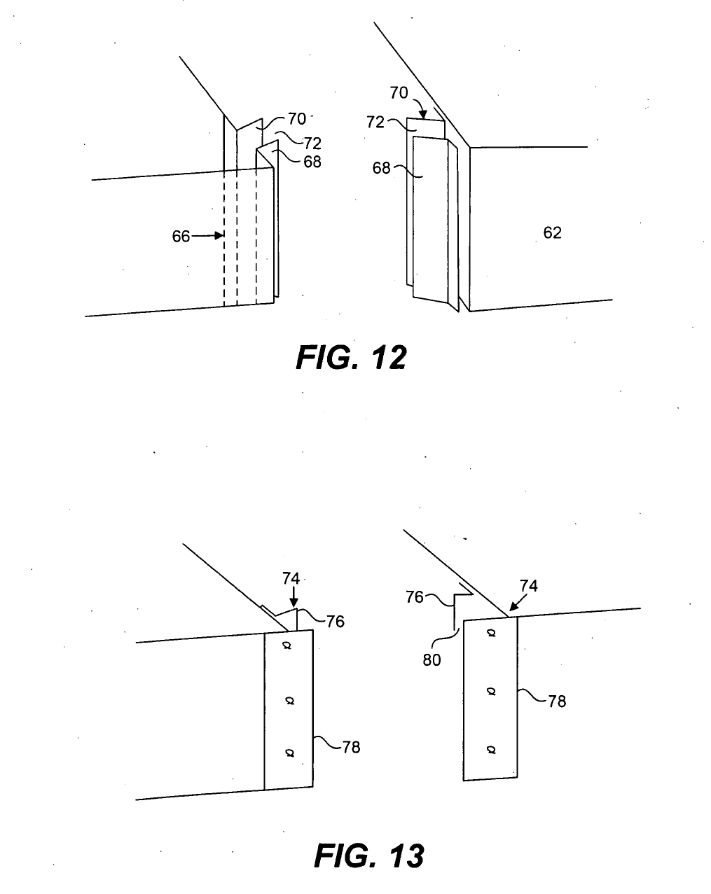

FIG. 13 shows another embodiment of the invention wherein a filter assembly 52 may be mounted using a pair of mounting assemblies 74 that each comprise an angle bracket 76 and a plate 78. The frame of the filter assembly 52 may slide down into a channel 80 formed between the angle bracket 76 and the plate 78.

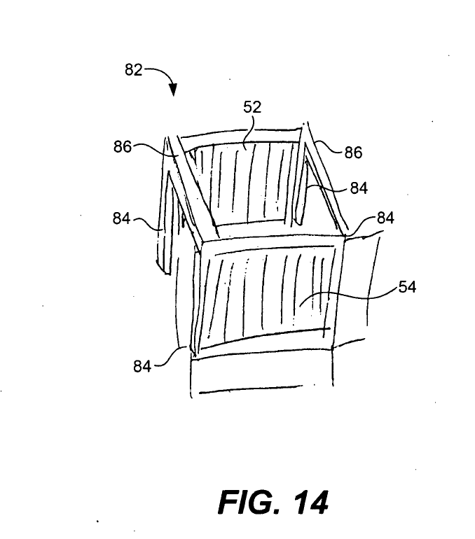

FIG. 14 shows another mounting assembly 82 for mounting both filter assemblies 52 and 54. The mounting assembly 82 includes four vertical L brackets 84 and two horizontal L brackets 86 configured in a box-like configuration. The frame of the filter assemblies 52 and 54 are attached to the vertical L brackets 84. The entire mounting assembly 82 with the filter assemblies 52 and 54 attached thereto may then be lowered over a weir 58.

It will be appreciated that there are many other modifications and applications for the present invention. For example, larger filter assemblies 52 may be used where the required flow rate is greater. Also filter assembly 52 may be used in an application where there is only a single container and the liquid flows out of the single pit or container through the filter assembly for other uses.

This invention is to be limited only by the following claims, which include all such embodiments and modifications when viewed in conjunction with the above specification and accompanying drawings.

We claim:

1. A filter assembly for filtering a fluid flowing from a first container into a second container comprising:
a filter panel disposed in a partition around a first container;
said filter panel including a bristle filter and a frame that holds the bristle filter, said bristle filter including a plurality of bristles attached at their proximate ends in an adjacent configuration along the length of a base; and
said filter panel disposed such that the upper ends of said bristles are above a top surface of said fluid in said first container and the lower ends of said bristles are below the top surface of said fluid in said first container.

2. The filter assembly of claim 1 further comprising a second container adjacent to said partition and wherein said filter panel is disposed in an aperture in said partition between said first.

3. The filter assembly of claim 2, wherein said aperture is a weir.

4. The filter assembly of claim 1 further comprising at least one seal positioned between said filter panel and a surface of said partition.

5. The filter assembly of claim 1, wherein said partition is a wall having an opening and said first filter panel is attached to one surface of said wall.

6. The filter assembly of claim 5 further comprising a second filter panel attached to an opposite surface of said wall.

7. The filter assembly of claim 1 further comprising a mount for holding said filter panel to said partition.

8. The filter assembly of claim 1, wherein said plurality of bristles are comprised of polypropylene.

9. The filter assembly of claim 4, wherein said at least one seal comprises a flexible rubber seal affixed to said filter panel, said flexible rubber seal arranged to cover a gap between said filter panel and said surface of said partition, and thereby directing water to said plurality of bristles.

10. The filter assembly of claim 7, wherein said mount is detachable from said partition.

11. The filter assembly of claim 2, wherein said first and second containers are adjacent settling ponds and said partition is a wall containing a weir at the upper edge and said filter panel is disposed in said weir such that fluid flowing from a first settling pond flows through said weir before flowing into a second settling pond.

12. A system for filtering liquid comprising:
first and second pits each containing a liquid;
a wall separating said pits;
a weir disposed at the top edge of said wall such that fluid flowing from said first pit to said second pit passes through said weir; and
a filter panel disposed in said weir, said filter panel including a bristle filter and a frame that holds the bristle filter, said bristle filter including a plurality of bristles attached at their proximate ends.

13. The system of claim 12, wherein said liquid is contaminated water.

14. The system of claim 12, wherein said liquid is cement slurry.

15. The system of claim 12 further comprising a second filter panel attached to said weir such that fluid passing out of said first filter panel then passes through said second filter panel before entering said second pit.

16. The system of claim 15, wherein the ends of said bristles in said first filter panel are oriented in an opposite direction as the ends of the bristles in said second filter panel.

17. The system of claim 12 wherein said plurality of bristles are comprised of polypropylene.

18. A method of filtering sediment-laden liquid and removing deposited sediment from said liquid comprising:
situating a filter panel in a first operational position proximate the top edge of a partition between first and second liquid containers, said filter panel comprising a bristle filter and a frame that holds the bristle filter, said bristle filter including a plurality of bristles attached at their proximate ends in an adjacent configuration along the length of a base; and
allowing said liquid to flow through said filter panel, from said first container to said second container, thereby filtering substances near the top of the surface of said fluid in said first container 19. The method of claim 18 further comprising: detaching said filter panel; cleaning said filter panel at a remote location; and returning said filter panel to its first position proximate to said storm drain inlet.

19. The method of claim 18 further comprising:
situating a second filter panel in a first operational position proximate the top edge of second partition between said second and a third liquid containers, said second filter panel comprising a bristle filter and a frame that holds the bristle filter, said bristle filter including a plurality of bristles attached at their proximate ends in an adjacent configuration along the length of a base; and
allowing said liquid to flow through said second filter panel, from said second container to said third container, thereby filtering substances near the top of the surface of said fluid in said second container.

20. The method of claim 19 further comprising extracting and reusing said liquid in said third container.
